(19) United States
(12) Patent Application Publication
(10) Pub. No.: US 2009/0322814 A1
(43) Pub. Date: Dec. 31, 2009

(54) RECORDING METHOD, RECORDING APPARATUS AND OPERATION CONTROL PROGRAM

(75) Inventor: Tsuyoshi SANO, Shiojiri-shi (JP)

Correspondence Address: LADAS & PARRY, 26 West 61st Street, New York, NY, 10023, US

(73) Assignee: SEIKO EPSON CORPORATION

(21) Appl. No.: 12/488,762

(22) Filed: Jun. 22, 2009

(30) Foreign Application Priority Data
Jun. 26, 2008 (JP) 2008-166920

(51) Int. Cl. B41J 29/38

(52) U.S. Cl. 347/12

(57) ABSTRACT

Provided is a recording method of attaching liquid droplets on a recording medium so as to form a printing image using a recording apparatus including a recording head divided into a first nozzle group, a second nozzle group and a third nozzle group in a transportation direction of the recording medium, the method including: ejecting a recording material from the first nozzle group with respect to the recording medium observable from an opposite side of a printing image forming surface and forming a first printing image; ejecting a shielding material from the second nozzle group and forming a second printing image shielding the first printing image; and ejecting the recording material from the third nozzle group and forming a third printing image to be superposed on the second printing image.

### BACKGROUND

1. Technical Field

The present invention relates to a recording method of ejecting a recording material from nozzles of a recording head and executing a recording process, a recording apparatus and an operation control program.

2. Related Art

An ink jet printer for printing an image including advertisement characters, symbols or the like on media such as transparent window glass, a film is known.

Even when only an image is directly printed on transparent media, an intermediate color consisting of high lightness, such as gray, other than a high-density color, such as red, blue, yellow, black, of the image is disturbed by light entering the image through the transparent media and thus cannot be accurately represented. Accordingly, various methods of printing images such as color images to be superposed on transparent media with a base color layer interposed there between are suggested.

In JP-A-2007-50555, a printer in which sub heads for image printing and sub heads for base color layer printing are disposed on a front side and a rear side in an X direction of an ink jet head is described. The base color layer is printed on the media by ink liquid droplets ejected from the sub heads for base color layer printing, which is reciprocally moved above the media in a Y direction. Subsequently, the media is moved in order in the X direction and after the sub heads for image printing reach above the base color layer printed on the media, the image is printed to be superposed on the surface of the base color layer by the ink liquid droplets ejected from the sub heads for image printing, which reciprocally moves above the base color layer in the Y direction.

The printer described in JP-A-2007-50555 prints an image forming layer to be superposed on an undercoat layer for fixing a based color layer or an image. In this case, the image is only observed from the image forming layer. This is premised on one-side printing.

Both-side printing may be performed by an ink jet printer. For example, in JP-A-2007-152736, by using a temperature detecting unit provided in the vicinity of a head substantially normally mounted in an ink jet printer for ink ejection control, a detected temperature by the temperature detecting unit is recognized as an environmental temperature under a specified condition, and the waiting time after a first printing surface is printed is altered in accordance with this environmental temperature to ensure a necessary and sufficient ink fixing time, and thereafter, printing on a second printing surface starts. When a recording medium waits for a predetermined time after recording of a front surface, the ink jet printer starts reverse transportation of the recording medium such that the recording medium is guided to a changeover member, is transported along an inverting path having a loop shape, and is fed to a recording unit again in a state in which the upper and lower surfaces and the front and back surfaces are inverted, and recording of the rear surface is performed.

In the both-side printing by the ink jet printer described in JP-A-2007-152736, when a predetermined time elapses after the printing of the front surface is performed with respect to the first printing surface, the printing of the rear surface is performed with respect to the second printing surface. Since printing is performed with respect to the front surface and the rear surface of the recording sheet, the image of the front surface and the image of the rear surface penetrate to each other. Accordingly, it is difficult to perform both-side printing with respect to the recording sheet.

### SUMMARY

An advantage of some aspects of the invention is that it provides a recording apparatus for outputting a recorded result for allowing images of a front surface and a rear surface of a recording medium to be viewed from the surfaces without penetrating the images to each other when viewed from either of the surfaces, a recording method and an operation control program.

According to an aspect of the invention, there is provided a recording method of attaching liquid droplets on a recording medium so as to form a printing image using a recording apparatus including a recording head divided into a first nozzle group, a second nozzle group and a third nozzle group in a transportation direction of the recording medium, the method including: ejecting a recording material from the first nozzle group with respect to the recording medium observable from an opposite side of a printing image forming surface and forming a first printing image; ejecting a shielding material from the second nozzle group and forming a second printing image shielding the first printing image; and ejecting the recording material from the third nozzle group and forming a third printing image to be superposed on the second printing image.

By this configuration, since the first printing image, the second printing image shielding the first printing image and the third printing image superposed on the second printing image are formed on one surface of the recording medium observable from the opposite side of the printing image forming surface, the first printing image can be viewed over the recording medium when viewed from the other surface on which the printing image is not formed. The first printing image shielded by the second printing image cannot be viewed, but the third printing image that is superposed last can be viewed, from the surface on which the printing image is formed. Accordingly, the recorded result in which the printing images can be viewed from the surfaces without penetrating the printing images to each other when viewed from either of the front surface and the rear surface of the recording medium is output. That is, only by forming the image only on one surface, the first printing image and the third printing image can be viewed from both surfaces of the recording medium and thus the printed result in which both-side printing seems to be performed can be output.

In the recording method of the invention, a white ink may be used as the shielding material.

By this configuration, since the white color has a property for reflecting light of all wavelengths, by using the white ink as the shielding material, the light of the color configuring the first printing image is reflected when the light penetrating through the recording medium reaches the first printing image. When the light is input from the third printing image side, the light of the color configuring the third printing image is reflected. That is, the lights of the colors configuring the first printing image and the third printing image are reflect off each other, the printed result of excellent color can be obtained when observed from either of the front and rear surfaces of the recording medium.

Recording data for forming the first printing image and recording data for forming the third printing image may be data inverted from each other, and the method may further include generating the inverted data.

By this configuration, since the data generated is inverted from each other, the first printing image viewed over the recording medium and the third printing image viewed from the surface on which the image is formed can be viewed as the same printing image. That is, the recorded result in which both-side printing of the same printing image seems to be performed can be obtained.

According to another aspect of the invention, there is provided a recording apparatus including: a recording head divided into a first nozzle group, a second nozzle group and a third nozzle group in a transportation direction of a recording medium; and a recording controller ejecting a recording material from the first nozzle group with respect to the recording medium observable from the opposite side of the print image forming surface and forming a first printing image, ejecting a shielding material from the second nozzle group and forming a second printing image shielding the first printing image, and ejecting the recording material from the third nozzle group and forming a third printing image to be superposed on the second printing image.

By this configuration, a recorded result for allowing images of a front surface and a rear surface of the recording medium to be viewed from the surfaces without penetrating the printing images to each other when viewed from either of the surfaces.

According to another aspect of the invention, there is provided an operation control program of a recording apparatus including a recording head divided into a first nozzle group, a second nozzle group and a third nozzle group in a transportation direction of a recording medium, the program causing the computer included in the recording apparatus to execute a method including: ejecting a recording material from the first nozzle group with respect to the recording medium observable from an opposite side of a printing image forming surface and forming a first printing image; ejecting a shielding material from the second nozzle group and forming a second printing image shielding the first printing image; and ejecting the recording material from the third nozzle group and forming a third printing image to be superposed on the second printing image.

By this configuration, only by installing the operation control program in the recording apparatus, it is possible to provide the recording apparatus for outputting a recorded result for allowing images of a front surface and a rear surface of the recording medium to be viewed from the surfaces without penetrating the printing images to each other when viewed from either of the surfaces.

### BRIEF DESCRIPTION OF THE DRAWINGS

The invention will be described with reference to the accompanying drawings, wherein like numbers reference like elements.

FIG. 1 is a schematic perspective view showing the main configuration of a printer according to an embodiment of the invention.

FIG. 2 is a block diagram showing the electrical configuration of the printer shown in FIG. 1.

FIG. 3 is a view schematically showing a state in which a printing head performs scanning in a main scanning direction and a transparent film is transported in a sub scanning direction.

FIG. 4 is a view schematically showing a state in which a printing head performs scanning in a main scanning direction and a transparent film is transported in a sub scanning direction.

FIG. 5 is a flowchart illustrating a printing method using the printer.

FIG. 6 is a schematic view of an image printed on a transparent sheet observed from a front surface and a rear surface thereof, wherein FIG. 6A is a view of the image observed from a print surface and FIG. 6B is a view of the image observed from a direction of the arrow denoted by Q of FIG. 6A.

FIG. 7 is a schematic view of an image printed on a transparent sheet observed from a front surface and a rear surface thereof when image data is not inverted, wherein FIG. 7A is a view of the image observed from a print surface and FIG. 7B is a view of the image observed from a direction of the arrow denoted by Q of FIG. 7A.

FIG. 8 is a schematic view of an image printed on a transparent sheet observed from a front surface and a rear surface thereof when a second shielding layer is printed only on one portion, wherein FIG. 8A is a view of the image observed from a print surface and FIG. 8B is a view of the image observed from a direction of the arrow denoted by Q of FIG. 8A.

### DESCRIPTION OF EXEMPLARY EMBODIMENTS

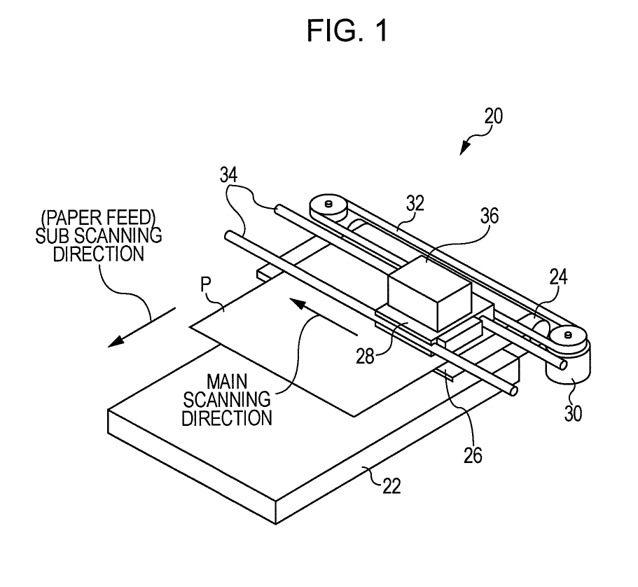

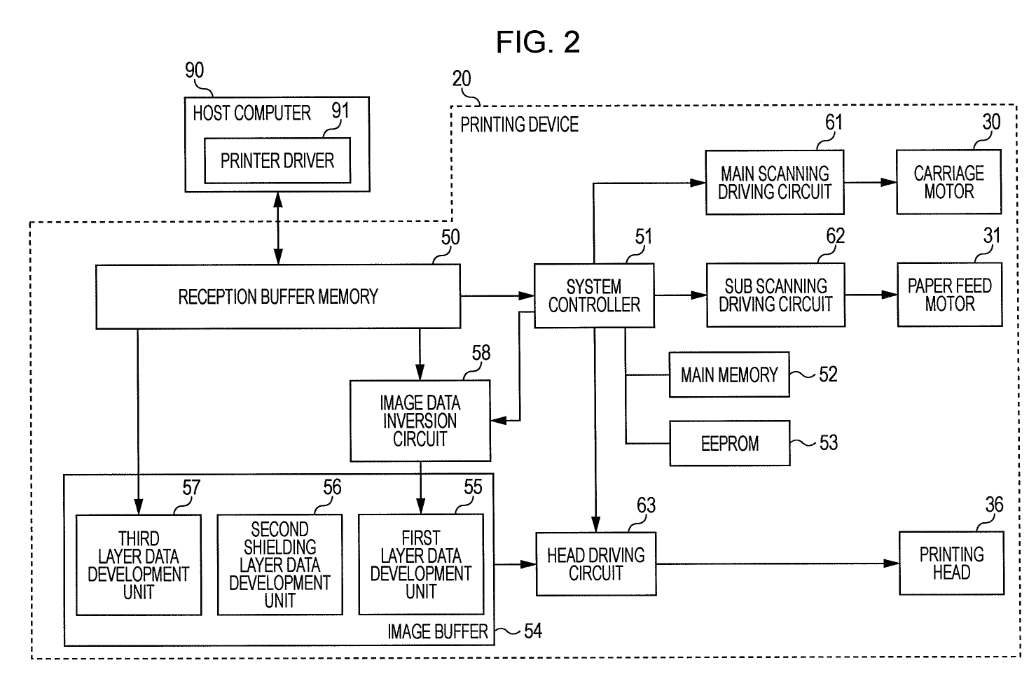

Hereinafter, a recording apparatus according to an embodiment of the invention will be described in detail with reference to the accompanying drawings. In addition, an ink jet printer (hereinafter, referred to as a “printer”) will be, for example, described as the recording apparatus. FIG. 1 is a schematic perspective view showing the main configuration of a printer according to an embodiment of the invention. FIG. 2 is a block diagram showing the electrical configuration of the printer shown in FIG. 1.

The printer 20 shown in FIG. 1 includes a paper stacker 22, a paper feed roller 24 driven by a step motor (not shown), a platen 26, a carriage 28, a carriage motor 30, a towing belt 32 driven by the carriage motor 30, and a guide rail 34 for guiding the scanning of the carriage 28. A printing head 36 (recording head) including a plurality of nozzles is mounted in the carriage 28.

Printing paper P (recording medium) is wound from the paper stacker 22 by the paper feed roller 24 and is sent onto the surface of the platen 26 in a sub scanning direction orthogonal to a main scanning direction of the printing head. In the present embodiment, the printing paper P is a transparent material through which light penetrates, such as a transparent film. The carriage 28 is towed by the towing belt 32 driven by the carriage motor 30 and is moved along the guide rail 34 in the main scanning direction.

As shown in FIG. 2, the printer 20 includes a reception buffer memory 50 for receiving a signal supplied from the host computer 90, an image buffer 54 for storing image data, a system controller 51 (recording controller) for controlling the overall operation of the printer 20, a main memory 52, and an EEPROM 53. Firmware stored in the EEPROM 53 is read to the main memory 52 and is executed such that various operations of the printer 20 are realized.

The system controller 51 is further connected with a main scanning driving circuit 61 for driving the carriage motor 30, a sub scanning driving circuit 62 for driving a paper feed motor 31, a head driving circuit 63 for driving the printing head 36, and an image data inversion circuit for inverting right and left sides of image data. The sub scanning driving circuit 62, the paper feed motor 31 and the paper feed roller 24 configure a paper feed mechanism. The system controller 51 controls the main scanning driving circuit 61, the sub scanning driving circuit 62 and the image data inversion circuit 58 according to various types of commands included in the printing data received by the reception buffer memory 50 or a setup condition written in the EEPROM 53 in advance.

For example, if a high-quality image is set to be printed, so-called interlace type printing is carried out which is for printing an image by the main scanning driving circuit 61 and the sub scanning driving circuit 62 while a raster is intermittently formed in the sub scanning direction. In addition the so-called overlap type printing can also be employed which is for printing an image by driving the nozzles for forming one raster at an intermittent timing.

The image buffer 54 of the present embodiment includes a first layer data development unit 55 in which image data printed as the first layer (first printing image) of the transparent film P is developed, a second shielding layer data development unit 56 in which image data printed as a second shielding layer (second printing image) of the transparent film P is developed, and a third layer data development unit 57 in which image data printed as a third layer (third printing image) of the transparent film P is developed. The image data of the printing data received by the reception buffer memory 50 is developed in the third layer data development unit 57 without change. Shielding data for shielding the first layer is developed in the second shielding layer data development unit 56. This shielding data may be generated by a printer driver 91 of the host computer 90 and may be transmitted to the printer 20 or held in a storage unit (not shown) of the printer 20 in advance. Inverted image data obtained by inverting the right and left sides of the image data received from the host computer 90 is developed in the first layer data development unit 57.

The image data inversion circuit 58 inverts the right and left sides of the image data received by the reception buffer memory 50 such that the image data is developed in the first layer data development unit 55.

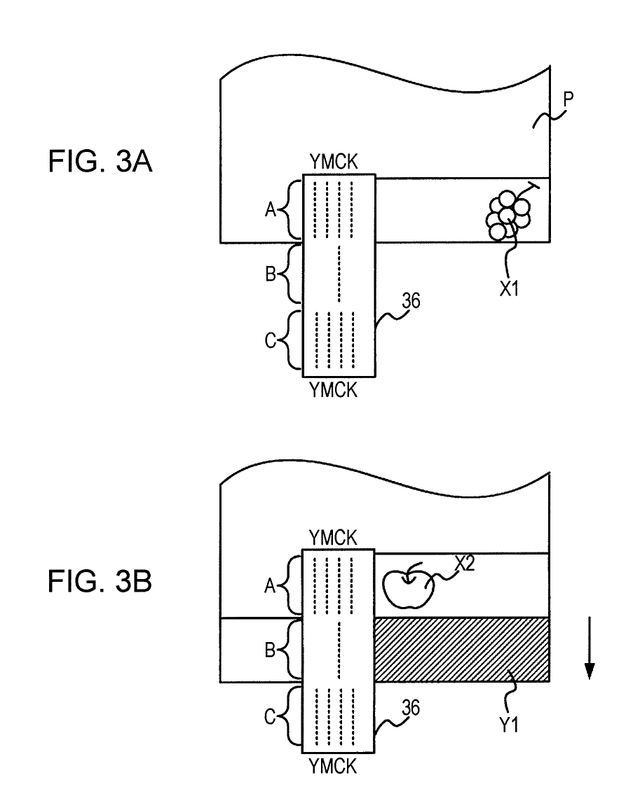

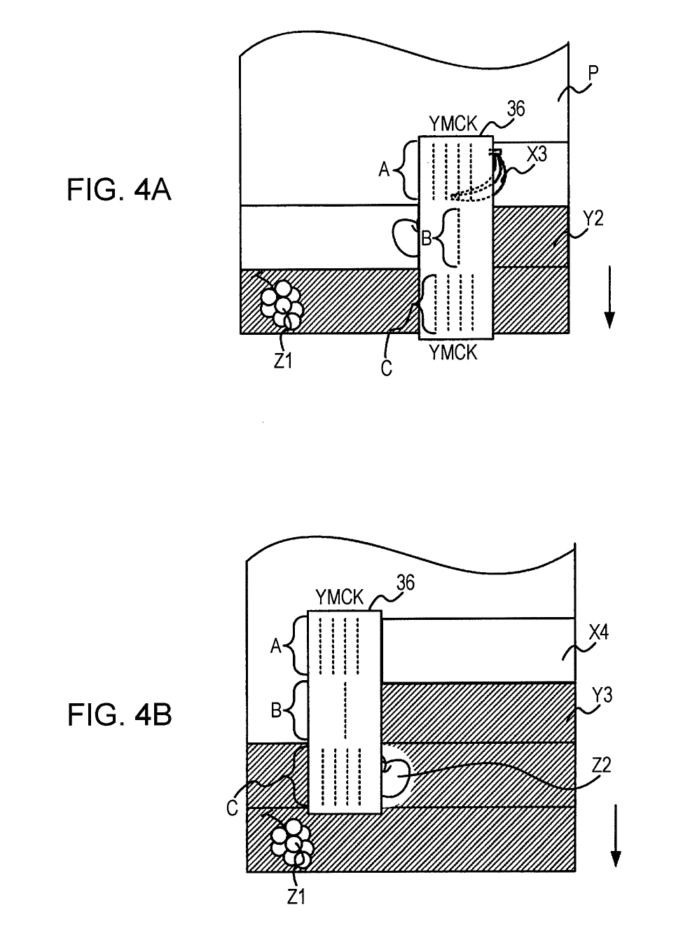

FIGS. 3 and 4 are views schematically showing a state in which the printing head performs scanning in the main scanning direction and the transparent film is transported in the sub scanning direction.

As shown in FIGS. 3 and 4, the nozzles of the printing head 36 included in the printer 20 according to the present embodiment are divided into three regions such as a first nozzle group A, a second nozzle group B and a third nozzle group C in the sub scanning direction (transportation direction of the recording medium).

The first nozzle group A and the third nozzle group C are color ink nozzle groups, and eject inks of Y (yellow), M (magenta), C (cyan) and K (black) from the left side thereof. The second nozzle group B is a nozzle group for ejecting a white ink used as a shielding material.

The head driving circuit 63 applies an ejection signal to the nozzles corresponding to the first nozzle group A based on the inverted image data developed in the first layer data development unit 55, applies an ejection signal to the nozzles corresponding to the second nozzle group B based on the shielding layer data developed in the second shielding layer data development unit 56, and applies an ejection signal to the nozzles corresponding to the third nozzle group C based on the image data developed in the third layer data development unit 57.

That is, the printer 20 according to the present embodiment ejects the color ink from the first nozzle group A based on the image data so as to print the first layer, ejects the white ink from the second nozzle group B based on the shielding data so as to print the second shielding layer for shielding the first layer, and ejects the color ink from the third nozzle group C based on the inverted image data so as to print the third layer to be superposed on the second shielding layer, with respect to the transparent film P.

Hereinafter, a printing method using the printer 20 will be described with reference to FIGS. 3 to 5.

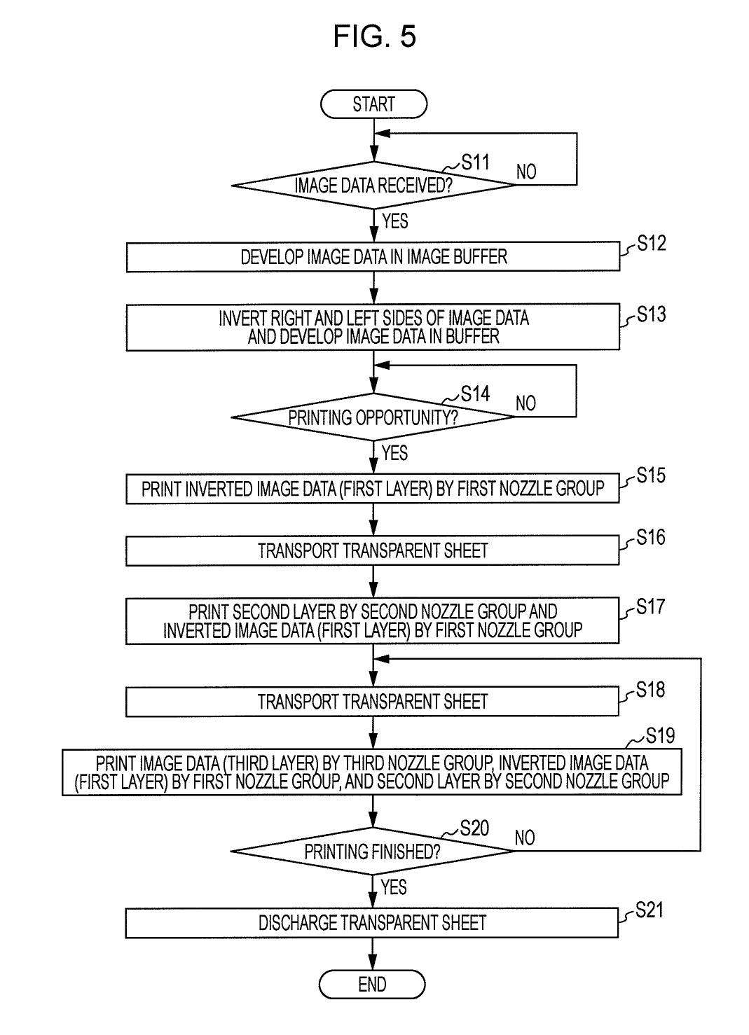

FIG. 5 is a flowchart illustrating the printing method using the printer.

When the printing data generated by the printer driver 91 is transmitted from the host computer 90 to the printer 20, first, the printing data is temporarily stored in the reception buffer memory 50. The printing data is sequentially read from the reception buffer memory 50 and, if a variety of command data is received, the system controller 51 analyzes the command.

If the image data is received (step S11: Yes), the image data is developed in the image buffer 54. The received image data is developed in the third layer data development unit 57 without change (step S12). In contrast, if a command for instructing both-side printing or both-side printing setup is read in advance, the system controller 51 drives the image data inversion circuit 58 so as to invert the right and left sides of the received image data and develops the inverted image data in the first layer data development unit 55 (step S13).

In addition, the system controller 51 reads the shielding layer data from a storage unit (not shown) and develops the shielding layer data in the second shielding layer data development unit 56. The shielding layer data is data which shields the inverted image data developed in the first layer data development unit 55 and covers an overall printable region, that is, a data for applying the ejection signal to all the nozzles of the second nozzle group B and ejecting the white ink from all the nozzles.

The shielding layer data does not need to be necessarily data for covering the overall printable region and may be the same data as the inverted image data. In this case, the same data as the inverted image data is developed in the second shielding layer data development unit 56, the white ink is ejected from some nozzles of the second nozzle group B, and only that portion is shielded.

If there is a printing opportunity (step S14: Yes), the system controller 51 drives the sub scanning driving circuit 62 and operates the paper feed motor 31 such that the transparent film P is exposed at a printing start position. In addition, the main scanning driving circuit 61 and the head driving circuit 63 are driven and the carriage motor 30 is operated such that the printing head 36 is moved in the main scanning direction, and the color ink is ejected from the nozzles corresponding to the first nozzle group A based on the inverted image data developed in the first layer data development unit 55 such that printing of the first layer X1 is started (step S15, see FIG. 3A).

Next, the paper feed motor 31 is driven such that the transparent film is transported by the height of the first nozzle group A (about ⅓ of the height of the printing head 36) (step S16). Meaning that the transparent film P is transported to a place where the second nozzle group B is located above the first layer X1. Then, the printing head 36 is moved in the main scanning direction, and the white ink is ejected from the nozzles corresponding to the second nozzle group B based on the shielding layer data developed in the second shielding layer data development unit 56 to be superposed on the first layer X1 such that the printing of the second shielding layer Y1 starts. Simultaneously, the first layer X2 is printed by the first nozzle group A (step S17, see FIG. 3B).

The paper feed motor 31 is driven such that the transparent film is transported by about ⅓ of the height of the printing head 36 (step S18). That is, the transparent film P is transported to a place where the third nozzle group C is located above the second shielding layer Y1. Then, the printing head 36 is moved in the main scanning direction, and the color ink is ejected from the nozzles corresponding to the third nozzle group C based on the image data developed in the third layer data development unit 57 to be superposed on the second shielding layer Y1 such that printing of the third layer Z1 is started. Simultaneously, the first layer X3 is printed by the first nozzle group A and the second shielding layer Y2 is printed by the second nozzle group B (step S19, see FIG. 4A).

If the printing process of the image data developed in the data development units 55, 56 and 57 is not finished (step S20: No), the process returns to the step S18 of driving the paper feed motor 31 such that the transparent film is transported by about ⅓ of the height of the printing head 36. That is, the transparent film P is transported to a place where the third nozzle group C is located above the second shielding layer Y2. Then, the printing head 36 is moved in the main scanning direction, and the color ink is ejected from the nozzles corresponding to the third nozzle group C based on the image data developed in the third layer data development unit 57 to be superposed on the second shielding layer Y2 such that printing of the third layer Z2 is started. Simultaneously, the first layer X4 is printed by the first nozzle group A and the second shielding layer Y3 is printed by the second nozzle group B (step S19, see FIG. 4B).

As described above, the step S18, the step S19 and the step S20 are repeatedly performed and, if the printing process of the image data developed in the data development units 55, 56 and 57 is finished (step S20: Yes), the transparent film P is discharged (step S21).

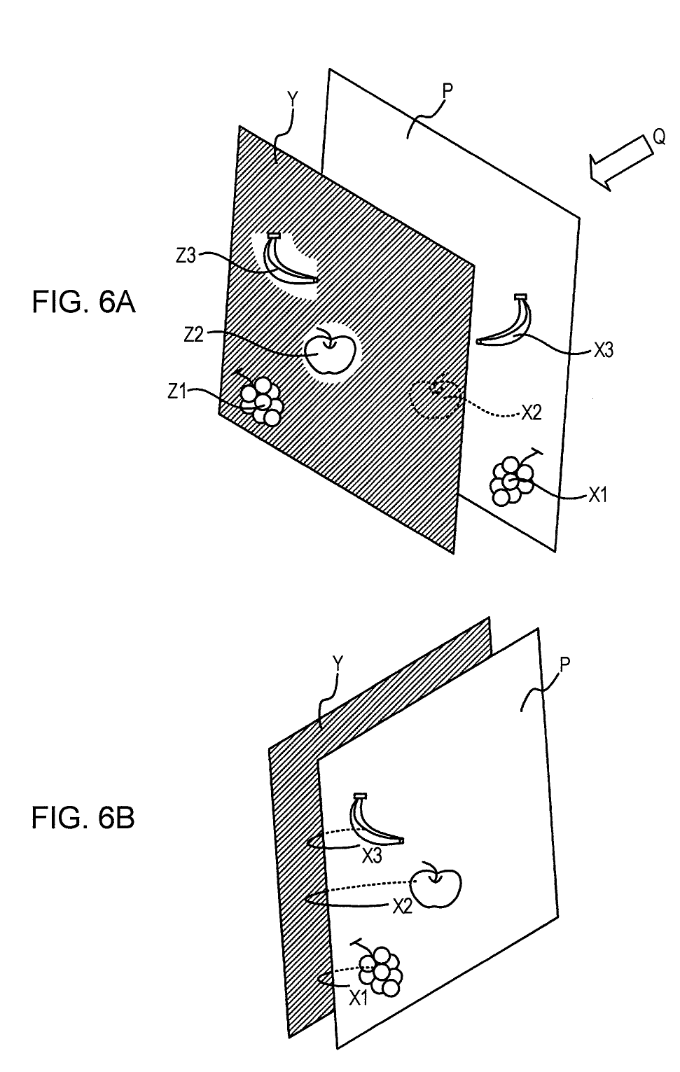

FIG. 6 is a schematic view of an image printed on a transparent sheet P observed from a front surface and a rear surface thereof, wherein FIG. 6A is a view of the image observed from a print surface and FIG. 6B is a view of the image observed from a direction of an arrow denoted by Q of FIG. 6A. Since the second shielding layer Y is formed between the first layer X (X1 to X3) and the third layer Z (Z1 to Z3) on the transparent film P printed according to the printing method of the present embodiment as shown in FIG. 6A, the first layer X and the third layer Z do not penetrate to each other to be seen. Although the one-side printing process is performed, a printed matter which seems to have been subjected to both-side printing can be produced.

Since the image data inversion circuit 58 generates the inverted data, the first layer X observed over the transparent film P (from the direction of the arrow denoted by Q) and the third layer Z observed from the surface subjected to the printing process can be viewed as the same image. That is, the printed result in which both-side printing of the same image seems to have been performed can be obtained.

According to the present embodiment, since the first layer X, the second shielding layer Y for shielding the first layer X and the third layer Z superposed on the second shielding layer Y are printed on one surface of the transparent film P, the first layer X can be viewed over the transparent film P when viewed from the other surface which is not subjected to printing. The first layer X shielded by the second shielding layer Y cannot be viewed, but the third layer Z superposed lastly can be viewed, from the surface subjected to the printing process. Accordingly, only by performing the printing process only with respect to one surface, the first layer X and the third layer Z can be seen from both surfaces of the transparent film P and thus the printed result in which both-side printing seems to be performed can be output.

Since the white ink employed in the present embodiment has a property for reflecting light of all wavelengths, the light of the color configuring the first layer is reflected when the light penetrating through the transparent film P reaches the first layer X. When the light is input from the third layer side, the light of the color configuring the third layer Z is reflected. That is, the lights of the colors of the first layer and the third layer reflecting off each other, the printed result of excellent color can be obtained when observed from either of the front and rear surfaces of the transparent film P.

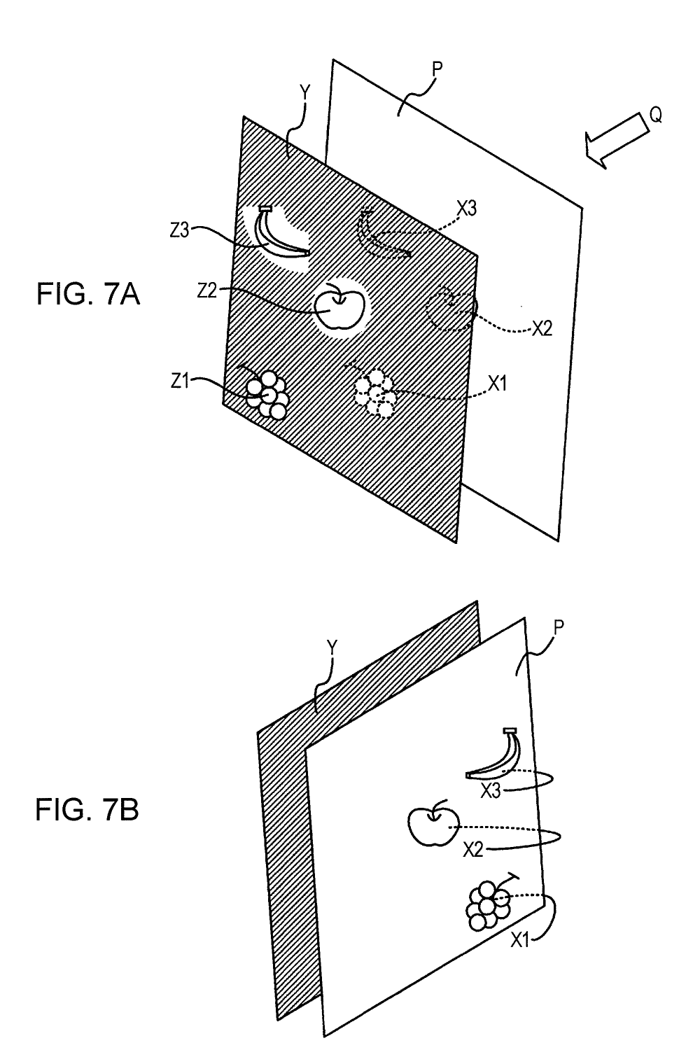

In addition, although, in the present embodiment, the inverted image data obtained by inverting the right and left sides of the image data received by the image data inversion circuit 58 is generated, a configuration in which image data is not inverted may be employed. FIG. 7 is a schematic view of an image printed on a transparent sheet P observed from a front surface and a rear surface thereof when image data is not inverted, wherein FIG. 7A is a view of the image observed from a print surface and FIG. 7B is a view of the image observed from a direction of the arrow denoted by Q of FIG. 7A.

Even in this case, since the second shielding layer Y is formed between the first layer X (X1 to X3) and the third layer Z (Z1 to Z3) on the printed transparent film P as shown in FIG. 7A, the first layer X and the third layer Z do not penetrate to each other to be seen. However, as shown in FIG. 7B, since the first layer X and the third layer Z are not the inverted image data, the first layer X observed over the transparent film and the third layer z observed from the surface subjected to the printing process can be viewed as the images, of which the right and left sides are inverted.

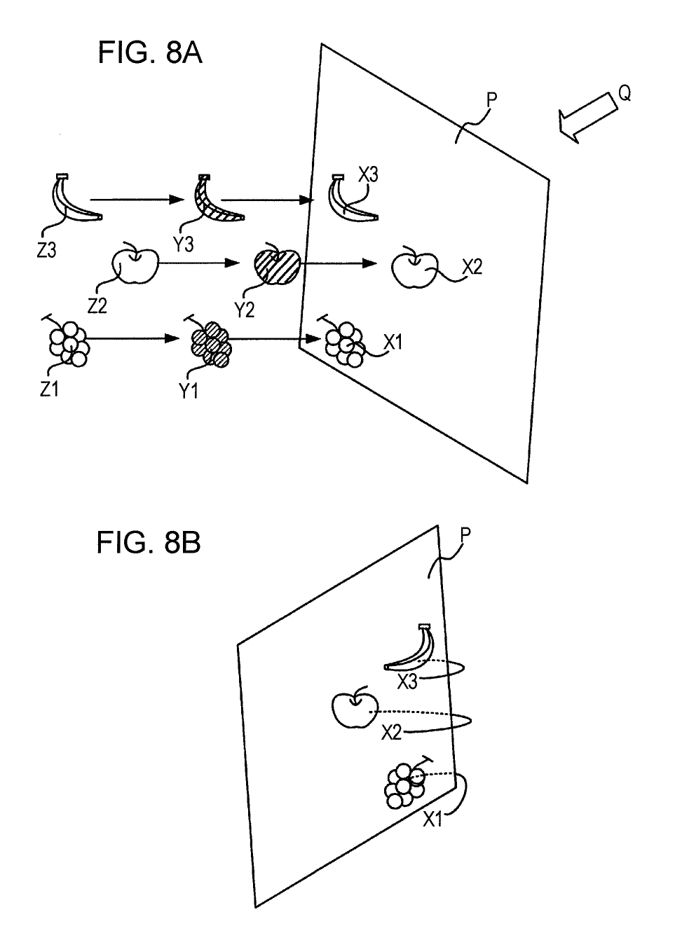

In addition, although in the above-described embodiment, the configuration in which the second shielding layer Y is printed on the front surface of the transparent film P, a portion printed actually may be shielded. FIG. 8 is a schematic view of an image printed on a transparent sheet P observed from a front surface and a rear surface thereof when the second shielding layer is printed only on one portion, wherein FIG. 8A is a schematic view of the image observed from a print surface and FIG. 8B is a view of the image observed from a direction of an arrow denoted by Q of FIG. 8A.

Even in this case, since the second shielding layers Y1, Y2 and Y3 are formed between the first layer X (X1 to X3) and the third layer Z (Z1 to Z3) on the printed transparent film P as shown in FIG. 8A, the first layer X and the third layer Z do not penetrate to each other to be seen. However, as shown in FIG. 8B, since the first layer X and the third layer Z are not the inverted image data, the first layer X observed over the transparent film and the third layer Z observed from the surface subjected to the printing process can be viewed as the images, of which the right and left sides are inverted.

In addition, although in the above-described embodiment, the printing paper P is the transparent material through which the light penetrates, such as the transparent film, a transmissive recording medium may be used. For example, a translucent recording medium may be used.

The arrangement of the nozzles of the printing head in the invention is not limited to the above-described embodiment and another arrangement may be employed. That is, a color ink nozzle group, a white ink nozzle group, and a color ink nozzle group may be arranged in this order in the sub scanning direction.

The shielding material of the invention is not limited to the white ink. That is, as a material having the effect for shielding the first layer X and the third layer, for example, another color such as a metallic ink may be employed.

What is claimed is:

1. A recording method of attaching liquid droplets on a recording medium so as to form a printing image using a recording apparatus including a recording head divided into a first nozzle group, a second nozzle group and a third nozzle group in a transportation direction of the recording medium, the method comprising:
ejecting a recording material from the first nozzle group with respect to the recording medium observable from an opposite side of a printing image forming surface and forming a first printing image;
ejecting a shielding material from the second nozzle group and forming a second printing image shielding the first printing image; and
ejecting the recording material from the third nozzle group and forming a third printing image to be superposed on the second printing image.

2. The recording method according to claim 1, wherein a white ink is used as the shielding material.

3. The recording method according to claim 1, wherein:
recording data for forming the first printing image and recording data for forming the third printing image are data inverted from each other, and
the method further includes generating the inverted data.

4. A recording apparatus comprising:
a recording head divided into a first nozzle group, a second nozzle group and a third nozzle group in a transportation direction of a recording medium; and
a recording controller ejecting a recording material from the first nozzle group with respect to the recording medium observable from an opposite side of a printing image forming surface and forming a first printing image, ejecting a shielding material from the second nozzle group and forming a second printing image shielding the first printing image, and ejecting the recording material from the third nozzle group and forming a third printing image to be superposed on the second printing image.

5. An operation control program of a recording apparatus including a recording head divided into a first nozzle group, a second nozzle group and a third nozzle group in a transportation direction of a recording medium, the program causing a computer included in the recording apparatus to execute a method comprising:
ejecting a recording material from the first nozzle group with respect to the recording medium observable from an opposite side of a printing image forming surface and forming a first printing image;
ejecting a shielding material from the second nozzle group and forming a second printing image shielding the first printing image; and
ejecting the recording material from the third nozzle group and forming a third printing image to be superposed on the second printing image.
